(19) United States
(12) Patent Application Publication
(10) Pub. No.: US 2020/0109285 A1
(43) Pub. Date: Apr. 9, 2020

(54) UV CURABLE SILICONE TERMINAL SEALANT

(71) Applicant: Dow Silicones Corporation, Midland, MI (US)

(72) Inventors: Qi Chen, Songjiang (CN); Lei Fang, Shanghai (CN); Peng Wei, Shanghai (CN); Yi Zhao, Shanghai (CN)

(21) Appl. No.: 16/495,619

(22) PCT Filed: Jun. 9, 2017
(86) PCT No.: PCT/CN2017/087690

§ 371 Date: Sep. 19, 2019

(51) Int. Cl. C08L 83/08; C08G 77/20; C08G 77/28; C08K 3/36; C08K 9/06; C08K 5/00; C08K 5/132; C08K 5/5397

(52) U.S. Cl. CPC C08L 83/08; C08G 77/20; C08G 77/28; C08K 3/36; C08L 2205/02; C08K 5/0041; C08K 5/132; C08K 5/5397; C08K 9/06

(57) ABSTRACT

A UV curable silicone composition, comprising: A) an alkenyl-containing organopolysiloxane that has at least two alkenyl groups in each molecule, at least one alkenyl group on each terminus; B) a photoinitiator; C) a mercapto-functional organopolysiloxane that comprises 2 or more mercapto groups per molecule; D) a pigment; and one or both of E) and F), where E) is a silica and F) is a solvent comprising a organopolysiloxane having ≤12 silicon atoms.

### CROSS-REFERENCE TO RELATED APPLICATIONS

None

### FIELD OF THE INVENTION

The present invention relates, generally, to a UV-curable silicone composition comprising an alkenyl-containing polysiloxane, a pigment, a photoinitiator, and one or both of a silane-treated silica and a solvent comprising an organosiloxane having ≤12 silicon atoms

### BACKGROUND OF THE INVENTION

Curable organopolysiloxane compositions are well known. Such compositions may be prepared by mixing polydiorganosiloxanes having curable (e.g., hydrolyzable, radiation curable, or heat curable) groups with crosslinking agents and/or catalysts, as needed. Generally, the polydiorganosiloxanes may have 1 to 3 reactive groups per chain end. Compositions including these components can then be cured, for example, by exposure to atmospheric moisture, exposure to radiation, or exposure to heat, depending on the curable groups present.

The cure rate of a particular composition depends on various factors including the type and number reactive group(s) present. It is known that different groups have different reactivity. For example, in the presence of moisture, a silicon-bonded acetoxy group will usually hydrolyze more rapidly than a silicon-bonded alkoxy group when all other conditions are the same. Furthermore, even the same type of curable group can have different reactivity depending on the number of those curable groups bonded to a particular silicon atom. For example, if a polydiorganosiloxane has three silicon-bonded alkoxy groups bonded to one silicon atom on a chain end, then the first alkoxy group is generally most reactive (reacts most quickly), but after the first alkoxy group reacts, it takes a longer time for the second alkoxy group bonded to the same silicon atom to react, and even longer for the third.

Furthermore, for certain applications a filler may be added to the composition to improve the physical property profile (e.g., increase tensile strength and increase % elongation to break) of the resulting cured product of the composition. The nature of the filler, its chemistry, particle size and surface chemistry have all been shown to influence the magnitude of the interaction between organopolysiloxanes and the filler and consequently the ultimate physical properties. Other properties such as adhesion and dispensability also play a role in the performance and commercial acceptance of a composition for different applications.

Existing curable compositions have some drawbacks in some application. For example, when used as terminal sealant in electronics applications, these curable compositions should cure quickly, and cure using low dosage UV radiation. In addition, the curable compositions should have good flowability, adequately fill gaps in and around the terminal, achieve extremely thin film thicknesses, have good repairability and show good re-workability.

### BRIEF SUMMARY OF THE INVENTION

The present invention is directed to UV curable silicone composition, comprising: A) an alkenyl-containing organopolysiloxane that has at least two alkenyl groups in each molecule, at least one alkenyl group on each terminus; B) a photoinitiator; C) a mercapto-functional organopolysiloxane that comprises 2 or more mercapto groups per molecule; D) a pigment; and one or both of E) and F), where E) is a silane-treated silica and F) is a solvent comprising a organopolysiloxane having ≤12 silicon atoms.

The present invention is further directed to a method of sealing the terminal of an electronic device, the method comprising applying a UV curable silicone composition, comprising: A) an alkenyl-containing organopolysiloxane that has at least two alkenyl groups in each molecule, at least one alkenyl group on each terminus; B) a photoinitiator; C) a mercapto-functional organopolysiloxane that comprises 2 or more mercapto groups per molecule; D) a pigment; and one or both of E) and F), where E) is a silane-treated silica and F) is a solvent comprising a organopolysiloxane having ≤12 silicon atoms, to a terminal, and exposing the UV curable silicone terminal sealant to UV radiation to form a cured silicone composition.

The curable silicone composition cures within a few seconds using low dosage UV radiation. In addition, the curable silicone compositions has good flowability, adequately fills gaps in and around the terminal of electronic devices when used to seal the terminal, achieves extremely thin film thickness, and shows good re-workability.

### DETAILED DESCRIPTION OF THE INVENTION

A UV curable silicone composition, comprising:

A) an alkenyl-containing organopolysiloxane that has at least two alkenyl groups in each molecule, at least one alkenyl group on each terminus;

B) a photoinitiator;

C) a mercapto-functional organopolysiloxane that comprises 2 or more mercapto groups per molecule;

D) a pigment; and

one or both of E) and F), where E) is a silica and F) is a solvent comprising a organopolysiloxane having ≤12 silicon atoms.

The alkenyl-containing organopolysiloxane has at least two alkenyl groups in each molecule with at least one alkenyl group on each terminus. The alkenyl of the alkenyl-containing organopolysiloxane is alkenyl comprising form 1 to 10 carbon atoms, alternatively 1 to 6 carbon atoms, alternatively 1 to 3 carbon atoms. The alkenyl in the alkenyl-containing organopolysiloxane can be exemplified by, but not limited to vinyl, allyl, isopropenyl, butenyl, hexenyl, and cyclohexenyl, alternatively vinyl. The bonding position for this alkenyl is on the molecular terminal of the polymer chain. However, the alkenyl may also be bonded in aide chain position in addition to the molecular polymer terminals. The alkenyl-containing organopolysiloxane has a substantially straight change molecular structure, but a portion of the molecular chain may be somewhat branched.

The viscosity of the alkenyl-containing organopolysiloxane at 25° C. is up to 25,000 centipoise (cPs), alternatively up to 5,000 cPs, alternatively from 200 to 3000 cPs. When the alkenyl-containing organopolysiloxane is a mixture of 2 or more alkenyl-containing organopolysiloxane, the viscosity of this mixture at 25° C. must be within the alternate ranges described immediately above.

In one embodiment, the alkenyl-containing organopolysiloxane contains the alkenyl group at percentage of at least 0.001% (w/w), alternatively at least 0.003% (w/w), alternatively from 0.001 to 3.5% (w/w), alternatively from 0.005% (w/w) to 1.0% (w/w), alternatively from 0.005 to 0.75, alternatively from 0.005 to 0.1% (w/w), alternatively 0.01 to 0.05% (w/w).

The mass-average molecular weight of the alkenyl-containing organopolysiloxane, on a standard polystyrene basis by gel permeation chromatography, is from 300 to 50,000, alternatively from 5000 to 40,000, alternatively from 10,000 to 30,000, alternatively from 15,000 to 25,000, alternatively from 17,000 to 23,000. When the alkenyl-containing organopolysiloxane is a mixture of two or more alkenyl-containing organopolysiloxane, the alkenyl-containing organopolysiloxane has a mass-average molecular weight, on a standard polystyrene basis by gel permeation chromatography, of from 15, to 25,000, alternatively from 17,000 t 23,000.

One skilled in the art would know how to make the alkenyl-containing organopolysiloxane. Alkenyl-containing organopolysiloxanes according to the invention are available commercially.

Examples of the alkenyl-containing organopolysiloxane include, but are not limited to dimethylpolysiloxanes (i.e., a polysiloxane comprising Me₂SiO_{2/2}, also known as “D,” groups) endblocked at both molecular chain terminals by dimethylvinylsiloxy groups (i.e. dimethylsiloxane-methylvinylsiloxane copolymers endblocked at both molecular chain terminals by dimethylvinylsiloxy groups, and mixtures thereof.

The photoinitiator can be any compound that undergoes a photoreaction on absoption of light to produce a reactive species to initiate the reaction of the alkenyl-containing organopolysiloxane and the mercapto-functional organopolysiloxane. Examples of the photoinitiator include, but are not limited to, 2-hydroxy-2-methyl-1-phenyl-propan-1-one, diphenyl(2,4,6-trimethylbenzoyl)phosphine oxide, and ethyl (2,4,6-trimethylbenzoyl) phenyl phosphinate. Photoinitiators are available commercially.

The a mercapto-functional organopolysiloxane comprises 2 or more mercapto groups per molecule. The mercapto groups are typically in the pendant position of the polysiloxane chain, although mercapto groups may be in a pendant position, alternatively the mercapto group must be in the pendant position on the polysiloxane chain. In one embodiment, the mercapto-functional organopolysiloxane is according to the following formula (I)

(I) [R¹₃SiO_{1/2}]ₓ[R¹(HSR²)SiO_{2/2}]_{y}[R¹₂SiO_{2/2}]_{z},

wherein x, y, and z are all >0 and y is from 0.01 to 0.3, alternatively 0.1 to 0.3, and z is from 0.69 to 0.98, alternatively 0.69 to 0.89, each R¹ is independently alkyl having from 1 to 8 carbon atoms, alternatively 1 to 6, alternatively 1 to 3. Examples of groups represented by R¹ include, but are not limited to, alkyl, such as methyl, ethyl, propyl, butyl, pentyl, hexyl, septyl, octyl, and their isomers. Each R² is independently hydrocarbylene having from 1 to 8 carbon atoms, alternatively 1 to 6, alternatively 1 to 3. Examples of groups represented by R² include, but are not limited to, methylene, ethylene, propylene, butylene, petylene, hexylene, septylene, octylene, and there isomers. In one embodiment, hydrocarbylene is limited to a divalent aliphatic group comprising carbon and hydrogen.

The viscosity of the mercapto-functional organopolysiloxane at 25° C. is from 10 to 50,000, alternatively from 25 to 2000 cPs, alternatively from 75 to 200 cPs. One skilled in the art would know how to measure the viscosity of a mercapto-functional organopolysiloxane. Organopolysiloxanes are available commercially according to their viscosities.

The molecular weight of the mercapto-functional organopolysiloxane can vary. In one embodiment, the molecular weight of the mercapto-functional organopolysiloxane is from 500 to 20,000, alternatively 1000 to 10,000, alternatively 2000 to 7000 as measured on standard polystyrene basis by gel permeation chromatography.

The mercapto-functional organopolysiloxane comprises from 1 to 6 mass %, alternatively from 2 to 5 mass %, alternatively from 3 to 4 mass % of mercaptan as SH. Once skilled in the art would know how to determine the mass % of mercapto group in the mercapto-functional organopolysiloxane.

Examples of the mercapto-functional organopolysiloxane includes, but is not limited to, dimethyl, methyl(mercaptopropyl)siloxane.

The mercapto-functional organopolysiloxane can be made by methods known in the art. For example, the mercapto-functional organopolysiloxane can be made by equilibration reaction of an alkoxyalkylmercaptosilane and a polydimethylsiloxane at elevated temperature in the presence of an acid catalyst. One skilled in the art would understand how to make the mercapto-functional organopolysiloxane of the invention.

The pigment comprises any pigment or color known to be used in curable compositions. Examples of pigments include, but are not limited to, CP-87(blue), CP-84(black), and 4-FS(white). One skilled in the art would know how to pick a pigment or color to be used in the composition of the invention. Pigments and colors are available commercially.

The UV curable silicone composition may comprise silica, alternatively comprises silica. The silica has a particle has a surface area from 50 to 10,000, alternatively from 50 to 1000, alternatively from 100 to 500 m²/g. In one embodiment, the silica is fumed silica. In another embodiment the silica is treated with a silane, alternatively a disilane, alternatively a disilazane, alternatively hexamethyldisilazane. In one embodiment, the silica is fumed silica treated with hexamethyldisilazane. Hexamethyldisilizane is available commercially.

The silica is treated with the silane by methods known in the art. For example, the silica and the alkenyl-containing organopolysiloxane may be mixed in a kneader followed by the addition of water and the silane to be used to treat the silica. In one embodiment, the silica is treated with 5 to 50% (w/w), alternatively 10 to 45% (w/w), alternatively 15 to 30% (w/w), based on the weight of the silica and the silane, of the silane.

The UV curable silicone composition may comprise a solvent, alternatively comprises a solvent. The solvent comprises a organopolysiloxane having ≤12 silicon atoms, alternatively less 8 silicon atoms, alternatively less than 5 silicon atoms.

The solvent has a vapor pressure less than 200 Pa, alternatively less than 150 Pa, alternatively less than 130 Pa, at 25° C.

Examples of the solvent include, but are not limited to, hexamethyldisiloxane, octamethyltrisiloxane, hexamethylcyclotrisiloxane, decamethyltetrasiloxane, and octamethylcyclotrisiloxane.

The UV curable silicone composition comprises from 20 to 40% (w/w), alternatively form 25-35% (w/w) of the alkenyl-containing organopolysiloxane, based on the total weight of the UV Curable silicone composition.

The UV curable silicone composition comprises from 0.01 to 10% (w/w), alternatively form 0.1 to 2% (w/w) of the pigment, based on the total weight of the UV Curable silicone composition.

The UV curable silicone composition comprises from 3 to 20% (w/w), alternatively form 5-15% (w/w) of the silica, based on the total weight of the UV Curable silicone composition.

The UV curable silicone composition comprises from 0.01 to 8% (w/w), alternatively form 0.5-4% (w/w) of the mercapto-functional silane, based on the total weight of the UV Curable silicone composition.

The UV curable silicone composition comprises a sufficient amount of photoinitiator to react with low dosage UV radiation and form reactive species that catalyze the curing of the UV curable silicone composition, a sufficient amount of photoinitiator is from at least 0.01% (w/w), alternatively form 0.1 to 5% (w/w) of the photoinitiator, based on the total weight of the UV Curable silicone composition.

The UV curable silicone composition comprises from 40 to 80% (w/w), alternatively form 50-60% (w/w) of the solvent comprising a organopolysiloxane having ≤12 silicon atoms, based on the total weight of the UV Curable silicone composition.

The UV curable silicone composition comprises a molar ratio of mercapto groups to vinyl groups of from 0.1 to 100, alternatively from 0.1 to 10, alternatively from 0.5 to 5.

There is no particular order of addition for making the UV curable silicone composition. Once skilled in the art would understand how to combine the components of the composition. For example, the silica is typically treated with the silane before mixing with ingredients that may react with the silane.

There is no particular temperature or pressure at with the composition must be made. Typically, the components of the composition are combined around room temperature (i.e., 20-25° C.) and pressure.

The time that the components of the UV curable silicone composition are mixed can vary. Typically, the components are mixed until uniform and then the mixing is stopped.

The UV curable composition of the invention can include other ingredients commonly used in curable silicone composition of this sort as long as they do not disrupt the physical properties desired of the composition. One skilled in the art would know additional materials that would be included.

The viscosity of the UV curable composition is from 50 to 10,000 cPs, alternatively from 50 to 1000 cPs, alternatively from 100 to 600 cPs, alternatively from 300 to 700 cPs. Viscosity is measure by the test procedure for measuring dynamic viscosity described in ASTM D3236-88(2009).

The cured UV curable silicone composition.

The dosage of UV radiation required to cure the UV curable composition can vary, alternatively the dosage required to cure the UV curable composition is less than 5000 mJ/cm², alternatively less than 4000 mJ/cm², alternatively less than 2000 mJ/cm².

The time required to cure the UV curable composition can vary, alternatively the time required to cure is less than 20 seconds (s), alternatively less than 10 s, alternatively less than 7 s, alternatively 5 s. One skilled in the art would know how to determine cure time.

The hardness of the cured UV curable silicone composition as measured by Shore A hardness according to ASTM D2240-05(2010) is from 15 to 30, alternatively 18 to 25, alternatively from 20 to 25, alternatively 23. One skilled in the art would know how to determine hardness according to ASTM D2240-05(2010).

The tensile strength of the cured UV curable silicone composition as measured according to ASTM D412-06ae2 is from 1 to 10, alternatively 3 to 5, alternatively from 4 to 5 MPa. One skilled in the art would know how to determine tensile strength according to ASTM D412-06ae2.

The elongation (%) of the cured UV curable silicone composition as measured according to ASTM D412-06ae2 is from 300 to 700, alternatively 400 to 600, alternatively from 525 to 560, alternatively 550. One skilled in the art would know how to determine elongation (%) according to ASTM D412-06ae2.

The cured UV curable silicone composition has a repairability of less than 10%. Repairability is measure of cohesive failure by applying a force of ≥0.88 Newton per millimeter (mm) of width to a film of less than 0.2 mm thickness.

A method of sealing a terminal of an electronic device, the method comprising: applying a UV curable silicone composition, comprising:

A) an alkenyl-containing organopolysiloxane that has at least two alkenyl groups in each molecule, at least one alkenyl group on each terminus;

B) a photoinitiator;

C) a mercapto-functional organopolysiloxane that comprises 2 or more mercapto groups per molecule;

D) a pigment; and

one or both of E) and F), where E) is a silane-treated silica and F) is a solvent comprising a organopolysiloxane having ≤12 silicon atoms,

to a terminal, and exposing the UV curable silicone terminal sealant to sufficient UV radiation to form a cured silicone composition.

The UV curable silicon composition components A), B), C), D), E), and F) are as described above.

The UV curable silicone composition is applied to the terminal according to methods known in the art. For example, the UV curable silicone composition by be applied to the terminal using a syringe or through a nozzle. One skilled in the art would know how to apply the UV curable silicone composition to a terminal.

The UV curable silicone composition is cured by exposing the UV curable silicone composition to UV radiation, alternatively less than 2000 millijoule/centimeter² (mJ/cm²). The exposing may be accomplished by positioning the UV curable silicone composition under a UV lamp emitting a sufficient dosage, alternatively less than 2000 mJ/cm², alternatively from 10 to 2000 mJ/cm². One skilled in the art would understand how to expose the UV curable silicone composition to UV radiation.

The method of the invention produced a cured UV curable silicone composition on a terminal which seals the terminal.

The terminal is a portion of an electronic device. Terminals are included in devices such as LED lighting and televisions and plasma televisions. One skilled in the art would understand what a terminal is.

The UV curable silicone composition of the invention provides the benefits of curing within a few seconds using low dosage UV radiation. In addition, the curable silicone compositions has good flowability, adequately fills gaps in and around the terminal of electronic devices when used to seal the terminal, achieves extremely thin film thickness. The cured UV curable silicone composition shows good terminal sealant properties including good re-workability. The method of the invention provides a terminal sealed with the UV curable sealant composition which provides excellent sealant and reworkability properties.

Organopolysiloxane and polyorganosiloxane are used interchangeably herein. Both are intended to mean an polysiloxane having organic groups attached to some or all of the silicon atoms of the polysiloxane.

### EXAMPLES

The following examples are presented to better illustrate the method of the present invention, but are not to be considered as limiting the invention, which is delineated in the appended claims. Unless otherwise noted, all parts and percentages reported in the examples are by weight. The following table describes the abbreviations used in the examples:

TABLE 1
List of abbreviations used in the examples.

| Abbreviation | Word |
|---|---|
| g | gram |
| Me | methyl |
| wt | weight |
| % | percent |
| mol | mole |
| hr | hour |
| ° C. | degrees Celsius |
| NA | Not Applicable |
| mL | milliliters |
| Solids | (wt. of dried sample/wt. of initial sample) × 100 |
| Content | and determined as described below |
| cm | centimeter1 |
| cPs | Centipoise |
| mJ | Millijoule |
| mm | millimeter |

Procedures:

Hardness—measured by Shore A hardness according to ASTM D2240-05(2010).
Tensile strength—measured according to ASTM D412-06ae2.
Elongation (%)—measured according to ASTM D412-06ae2.
Repairability—The repairability of a material is evaluated by determining the adhesive strength of a specific laminate using a one hundred and eighty degree peel separation. The substrates are coated with the material to be tested and allowed to cure. The two cured portions are then laminated using a fresh portion of the material to create the bond. After the material has cured, the laminate is peeled apart on any equipment suitable for testing rubber tensile strength, and the average load required to separate it is reported in pounds per inch of width. A 3×6×0.040 inch panel of a rigid substrate and either a 3×12 inch 30 mesh screen or a solid strip 0.25 of 1 inch wide flexible substrate were used. The substrates were first cleaned by wiping the pieces with a clean piece of cotton gauze first with trichloroethylene, then methyl isobutyl ketone and finally acetone and allowed to dry. The substrates were then allowed to condition at around 77° F. and 50% relative humidity (RH) for 30 minutes and then primed with the specified primer for the substrate and dried. The elastomeric material was applied to both substrates using a drawdown techniques and appropriate shims to produce layers of 0.22 mm thickness. The layers are then allowed to cure for 4 hours at 77° F. and 50% RH. Next, a fresh layer of material 0.025 plus or minus 0.001 cm thick was spread onto the elastomeric material on the rigid substrate, and the elastomeric surface of the flexible substrate was immediately put into contact with the with the fresh material so the long dimensions are parallel and one end of the flexible substrate is free of the panel. The laminate was then gently pressed together to produce a specified glue line. The laminate was then cured at 77° F. and 50% RH. A strip 2.54 cm wide and the full length of the panel was then cut partially through the elastomeric material on the rigid substrate without exposing the bare surface of the rigid substrate. Next, starting at the free end of the flexible substrate, it was cut loose from the elastomeric material on the rigid substrate for about 2.5 cm using a razor blade. The flexible substrate was then bent back 180 degrees against the rigid substrate. The end of the flexible substrate was then attached to the load detecting grip of the rubber tensile tester. The grips of the tester were more than 2.5 cm wide. The laminate was then pulled apart at a rate of 5 cm/min. with a force of ≥0.88 Newton per millimeter of width to a film of less than 0.2 thickness and for the full length of the panel. The load curve was recorded during the pull. The average load in pounds per inch were recorded. The results are qualitative.
Molecular weight—measured by gel permeation chromatography using polystyrene standard.
Viscosity was measure by

### Example 1

### Ingredients used in Example 1

A—dimethylpolysiloxane endblocked at both molecular chain terminals by dimethylvinylsiloxy groups; viscosity 2200 cPs.
B—hexamethyldisilazane treated fumed silica; surface area 200 m²/g; 20% silane treated, based on weight of the silane and silica.
C—solvent; hexamethyldisiloxane
D—CP-87 (blue pigment)
E—trimethylsilyl-endcapped dimethyl, methyl(mercaptopropyl)siloxane; molecular weight 4000-5000; viscosity 70 to 130, 3.2-4.0 mass % mercaptan as SH.
F—photoinitiator; 2-hydroxy-2-methyl-1-phenyl-propan-1-one.
The formulation in the following table was prepared by mixing A and B at room temperature in a kneader. The combination of A and B were then added to a batch mixer with the remaining ingredients in order with mixing. The formulation was blue in appearance and had a viscosity of 4550 cPs.

| Ingredients | Weight % |
|---|---|
| A | 30.89 |
| B | 10.85 |
| C | 55.10 |
| D | 0.535 |
| E | 2.09 |
| F | 0.535 |

The formulation above was then cured and tested using the procedures describe above. The results are in the following table.

| Curing condition | UV dosage <2000 mJ/cm² |
|---|---|
| Curing time | 5 s |
| Hardness (Shore A) | 23 |
| Tensile strength (mPa) | 4.3 |
| Elongation (%) | 550 |
| Repairability (.0.2 mm | good |
| thickness) | |

The results above demonstrate that the composition of the invention cures quickly using low dosage UV radiation and provides good tensile strength, hardness, elongation and repairability.

1. A UV curable silicone composition, comprising:
A) an alkenyl-containing organopolysiloxane that has at least two alkenyl groups in each molecule, at least one alkenyl group on each terminus;
B) a photoinitiator;
C) a mercapto-functional organopolysiloxane that comprises 2 or more mercapto groups per molecule;
D) a pigment; and
one or both of E) and F), where E) is a silica and F) is a solvent comprising a organopolysiloxane having ≤12 silicon atoms.

2. The composition according to claim 1, wherein the composition comprises both E) and F).

3. The composition according to claim 1, wherein the alkenyl-containing organopolysiloxane has a viscosity of up to 25000 cPs.

4. The composition according to claim 1, wherein the alkenyl-containing organopolysiloxane vinyldimethylsiloxy-terminated polydimethylsiloxane.

5. The composition according to claim 1, wherein the mercapto-functional organopolysiloxane is according to the following formula (I)
(I) [R¹₃SiO_{1/2}]ₓ[R¹(HSR²)SiO_{2/2}]_{y}[R¹₂SiO_{2/2}]ₓ,
wherein x, y, and z are all >0, each R¹ independently is hydrocarbyl having from 1 to 8 carbon atoms, R² is hydrocarbylene having from 1 to 8 carbon atoms.

6. The composition according to claim 5, wherein R¹ is methyl and R² is propylene.

7. The composition according to claim 1, the composition comprises 20 to 40% (w/w) of the alkenyl containing organopolysiloxane.

8. The composition according to claim 1, wherein the silica is hexamethyldisilazane-treated fumed silica.

9. The composition according to claim 1, wherein the solvent has a vapor pressure of less than 200 Pa at 25° C.

10. The composition according to claim 9, wherein the solvent comprises one or more of hexamethyldisiloxane, octamethyltrisiloxane, hexamethylcyclotrisiloxane, decamethyltetrasiloxane, and octamethylcyclotrisiloxane.

11. A cured UV curable silicone composition obtained by curing the compositions of claim 1.

12. A method of sealing a terminal of an electronic device, the method comprising:
applying a UV curable silicone composition, comprising:
A) an alkenyl-containing organopolysiloxane that has at least two alkenyl groups in each molecule, at least one alkenyl group on each terminus;
B) a photoinitiator;
C) a mercapto-functional organopolysiloxane that comprises 2 or more mercapto groups per molecule;
D) a pigment; and
one or both of E) and F), where E) is a silane-treated silica and F) is a solvent comprising a organopolysiloxane having ≤12 silicon atoms,
to a terminal, and exposing the UV curable silicone terminal sealant to sufficient UV radiation to form a cured silicone composition.
